(19) United States
(12) Patent Application Publication
(10) Pub. No.: US 2009/0088309 A1
(43) Pub. Date: Apr. 2, 2009

(54) Glass Composition

(75) Inventors: Haruki Niida, Tokyo (JP); Akihiro Koyama, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: Nippon Sheet Glass Company, Limited, Tokyo (JP)

(21) Appl. No.: 12/223,738

(22) PCT Filed: Feb. 14, 2007
(86) PCT No.: PCT/JP2007/052642

§ 371 Date: Aug. 7, 2008

(30) Foreign Application Priority Data
Feb. 14, 2006 (JP) 2006-036806

(51) Int. Cl. C03C 3/118; C03C 3/097; C03C 3/093; C03C 3/091; C03C 3/089; C03C 3/115; C03C 3/11; C03C 3/112; C03C 3/087; C03C 3/085; C03C 3/083; C03C 3/078

(52) U.S. Cl. 501/59; 501/63; 501/67; 501/66; 501/65; 501/70; 501/69; 501/68; 501/72; 501/58; 501/57; 501/56

(57) ABSTRACT

A glass composition of the present invention includes the following components, in terms of mass % and mass ppm: 60 to 79% SiO₂; 0 to 13% B₂O₃ (exclusive of 13%); 0 to 10% Al₂O₃; 0 to 10% Li₂O; more than 0% but not more than 20% Na₂O; 0 to 15% K₂O; 0 to 10% MgO; 0 to 15% CaO; 0 to 15% SrO; 0 to 15% BaO; 0 to 10% ZnO; 0 to 15% Nb₂O₅; 0 to 20% Ta₂O₅; more than 0.02% but not more than 10% TiO₂; and 0.5 to 50 ppm T-Fe₂O₃ (where T-Fe₂O₃ denotes a total iron oxide obtained by converting all of iron compounds into Fe₂O₃).

### TECHNICAL FIELD

The present invention relates to a glass composition, in particular to a glass composition that reduces fluorescence emitted through irradiation of excitation light so that it can be used suitably for a cover glass and the like, and further to a glass substrate made of the composition.

### BACKGROUND ART

In the field of observation of living bodies, particularly in the field of observation or the like of tissues and cells of living organisms, observation using an optical microscope is still a commonly used technique. Conventionally, transmission and reflection of visible light have been utilized for the observation of living bodies using an optical microscope.

Meanwhile, in recent years, a technique has been used in which an observation object is irradiated with near-ultraviolet light or visible light as excitation light to observe fluorescence in the visible light region emitted from the observation object. See, for example, JP 2006-030583 A.

When observing a living body using an optical microscope, a slide glass and a cover glass are used widely. In particular, a cover glass is necessary to focus the optical system of an optical microscope on an observation object. In order to observe the cells of the object utilizing fluorescence emitted from the object when excited by visible light, the excitation light is irradiated to the cells through the cover glass. Hence, fluorescence emitted from the cover glass must be suppressed in order not to interfere with the observation of fluorescence even when the excitation light is irradiated to the cover glass.

Conventionally, zinc borosilicate glass often has been used as a cover glass. This zinc borosilicate glass has optical constants including a refractive index n_{d} of 1.523 to 1.525 and an Abbe number ν_{d} of 54 to 55, taking an optical system of a microscope into consideration.

However, since fluorescence emitted from this cover glass is too strong when the object is irradiated with visible light as excitation light through the cover glass, it may be impossible in some cases to observe fluorescence from the object itself. As just described, it is difficult to observe the fluorescence from the object without reducing the fluorescence emitted from the glass when it is irradiated with excitation light.

A typical example of glass that emits weaker fluorescence when it is irradiated with visible light as excitation light is silica glass.

In addition, Japanese Patent No. 2634063 discloses a cover glass for a solid-state image sensor including SiO₂, B₂O₃ and Al₂O₃ as well as Fe₂O₃ in an amount of 55 to 200 ppm so as to suppress the generation of fluorescence.

However, the glasses described above have the following problems.

Firstly, silica glass emits less fluorescence when it is irradiated with visible excitation light. However, it has a very small refractive index n_{d} of about 1.46, which is not compatible with an optical system of a conventional optical microscope. Therefore, when silica glass is used as a cover glass, an accurate observation image of an observation object cannot be obtained.

Next, in the above-mentioned cover glass for a solid-state image sensor described in Japanese Patent No. 2634063, the amount of Fe₂O₃ in particular is limited to 55 to 200 ppm so as to suppress the generation of fluorescence while maintaining its ultraviolet ray transmission.

However, a glass composition of Example 4 has a very small refractive index n_{d} of 1.516, even though it has the highest refractive index of all Examples. In addition, the Abbe number thereof is 64, which is too large. Thus, as with silica glass, when a conventional optical microscope is used, an accurate observation image of an observation object cannot be obtained.

Commercially available cover glasses are made of zinc borosilicate glass, and their refractive indices and Abbe numbers are suitable for cover glasses. However, when an object is irradiated with visible light as excitation light using this type of glass as a cover glass, fluorescence emitted from the glass is too strong, which may cause difficulty in observing fluorescence from the object itself.

### DISCLOSURE OF INVENTION

In view of these circumstances, it is an object of the present invention to provide a glass composition suitable for a glass substrate having optical properties suitable for a cover glass. Further, it is another object to provide a glass composition that can reduce fluorescence emitted from the glass when it is irradiated with visible light as excitation light.

As a result of intensive studies on glass compositions, the present inventors have found out that, by controlling the content of iron oxides in a glass composed of SiO₂—Na₂O—TiO₂ and further in a glass composed of SiO₂—Al₂O₃—Na₂O—TiO₂, fluorescence emitted from the glass when it is irradiated with visible light as excitation light can be reduced. Thus, the present invention has been achieved.

The present invention provides a glass composition including the following components, in terms of mass % and mass ppm:

60 to 79% SiO₂;

0 to 13% B₂O₃ (exclusive of 13%);

0 to 10% Al₂O₃;

0 to 10% Li₂O;

more than 0% but not more than 20% Na₂O;

0 to 15% K₂O;

0 to 10% MgO;

0 to 15% CaO;

0 to 15% SrO;

0 to 15% BaO;

0 to 10% ZnO;

0 to 15% Nb₂O₅;

0 to 20% Ta₂O₅;

more than 0.02% but not more than 10% TiO₂; and

0.5 to 50 ppm T-Fe₂O₃ (where T-Fe₂O₃ denotes a total iron oxide obtained by converting all of iron compounds into Fe₂O₃).

In another aspect, the present invention provides a glass substrate made of the above-mentioned glass composition. This glass substrate can be used suitably for the observation using a fluorescence microscope.

### BRIEF DESCRIPTION OF DRAWINGS

FIG. 1 is a graph showing a relationship between contents of T-Fe₂O₃ included in glass compositions and relative fluorescence intensity ratios thereof.

### BEST MODE FOR CARRYING OUT THE INVENTION

The reasons for limiting each component in the glass composition of the present invention are as follows. It should be noted that “%” and “ppm” hereinafter will denote “mass %” and “parts per million by mass”, respectively.

### (SiO₂)

SiO₂ is an essential component that forms a glass network. When the content of SiO₂ is less than 60%, chemical durability of the glass has been deteriorated. On the other hand, when the content of SiO₂ exceeds 79%, the viscosity of the glass melt becomes so high that the melting and the refining of the glass become difficult. Thus, the content of SiO₂ needs to be 60 to 79%. The content of SiO₂ is preferably 60 to 75%.

When B₂O₃ is included as an essential component, the content of SiO₂ is more preferably 60 to 71%, and further preferably 62 to 71%. On the other hand, when B₂O₃ is not included, the content of SiO₂ is more preferably 62 to 75%.

### (B₂O₃)

B₂O₃ is an optional component. B₂O₃ is effective in lowering the melting temperature of glass. However, when the Upper Limit of the Content of B₂O₃ is 13% or more, the chemical durability decreases significantly. Furthermore, striae may appear in glass articles due to volatilization of B₂O₃ from the glass melt in melting the glass composition. Thus, the content of B₂O₃ needs to be less than 13%, and is preferably 12% or less. Furthermore, when B₂O₃ is included as an essential component, the content of B₂O₃ is preferably more than 0% but not more than 12%, and more preferably 6 to 10%. Meanwhile, the glass composition may be substantially free from B₂O₃.

In the present description, the phrase “substantially free from” means that a substance is intentionally excluded, except for an unavoidable admixture thereof from an industrial raw material, for example. Specifically, it refers to a content of less than 0.1%. Preferably, the content is less than 0.05%, and more preferably less than 0.01% (100 ppm). In this regard, however, this definition does not apply to a refining agent and T-Fe₂O₃. This is because the refining agent is almost completely volatilized and only a trace amount thereof remains even if it is added intentionally, and because the content of T-Fe₂O₃ in ppm scale causes a problem.

### (Al₂O₃)

Although Al₂O₃ is an optional component, it is a component that preferably is included. Al₂O₃ is effective in enhancing the chemical durability of glass. However, since Al₂O₃ has an effect of increasing the viscosity of the glass melt, when the upper limit of the content of Al₂O₃ exceeds 10%, it becomes difficult to melt the glass composition. Thus, the content of Al₂O₃ needs to be 10% or less, and is preferably 6% or less. Preferably, the lower limit of the content of Al₂O₃ exceeds 0%, and more preferably 1% or more.

### (Na₂O)

Na₂O is an essential component. Na₂O is effective in decreasing the viscosity of the glass melt and improving the meltability thereof. However, when the content of Na₂O is excessively large, the chemical durability of the glass may be deteriorated. Thus, the content of Na₂O needs to be more than 0% but not more than 20%. Preferably, the content of Na₂O is 1 to 15%. More preferably, the content of Na₂O is 4 to 15%. When B₂O₃ is included in the glass, it is further preferable that the content of Na₂O is 4 to 10%.

### (K₂O)

K₂O is an Optional Component. Like Na₂O, K₂O is Effective in decreasing the viscosity of the glass melt and improving the meltability thereof. On the other hand, when the content of K₂O is excessively large, the chemical durability of the glass may be deteriorated. Thus, the content of K₂O needs to be 15% or less, and is preferably 10% or less. When B₂O₃ is included in the glass, it is more preferable that the content of K₂O is 4 to 10%.

### (Li₂O)

Li₂O is an optional component. Like Na₂O, Li₂O is effective in decreasing the viscosity of the glass melt and improving the meltability thereof. However, when the content of Li₂O is excessively large, the chemical durability of the glass may be deteriorated. Thus, the content of Li₂O needs to be 10% or less, and is preferably 5% or less. More preferably, the glass composition is substantially free from Li₂O.

### (Total Content of Na₂O, K₂O and Li₂O)

As described above, when the contents of Na₂O, K₂O and Li₂O included in the glass composition are excessively large, undesirable effects such as a deterioration in chemical durability are caused. Therefore, the total content of Na₂O, K₂O and Li₂O is preferably 25% or less, more preferably 20% or less, and further preferably 15% or less.

### (MgO and CaO)

MgO and CaO are optional components. They, however, are components that preferably are contained. MgO and CaO are effective in decreasing the viscosity of the glass melt and improving the meltability thereof. In addition, MgO and CaO are effective in improving the chemical resistance of the glass. However, when the content of MgO exceeds 10%, or the content of CaO exceeds 15%, devitrification tends to be generated in the glass, which results in difficulty in forming the glass melt into glass articles.

Thus, the content of MgO needs to be 10% or less. When B₂O₃ is included in the glass, it is preferable that the glass is substantially free from MgO. When B₂O₃ is not included in the glass, the content of MgO is preferably 0 to 8%, and more preferably 1 to 8%.

The content of CaO needs to be 15% or less. When B₂O₃ is included in the glass, it is preferable that the glass is substantially free from CaO. When B₂O₃ is not included in the glass, the content of CaO is preferably 3 to 12%.

### (SrO and BaO)

SrO and BaO are optional components. Similarly to MgO and CaO, SrO and BaO are effective in decreasing the viscosity of the glass melt and improving the meltability thereof. In addition, SrO and BaO are effective in improving the chemical resistance of the glass composition. However, since SrO and BaO are components that increase the refractive index n_{d} significantly, when a large amount of SrO and BaO is included in the glass composition, the refractive index of the glass may increase excessively.

Thus, the content of SrO needs to be 15% or less, and is preferably 10% or less. It is more preferable that the glass composition is substantially free from SrO.

Similarly, the content of BaO needs to be 15% or less, and is preferably 10% or less. It is more preferable that the glass composition is substantially free from BaO.

### (ZnO)

ZnO is an optional component. Similarly to MgO and CaO, ZnO is effective in decreasing the viscosity of the glass melt and improving the meltability thereof. However, striae may appear in glass articles due to volatilization of ZnO from the glass melt in melting the glass composition. In addition, when the content of ZnO is excessively large, fluorescence from the glass may be induced. Thus, the content of ZnO needs to be 10% or less, and is preferably 0 to 8%. When B₂O₃ is included in the glass, it is more preferable that the content of ZnO is 3 to 8%.

### (Nb₂O₅ and Ta₂O₅)

Nb₂O₅ and Ta₂O₅ are optional components. Although Nb₂O₅ and Ta₂O₅ are components that decrease the Abbe number, they are relatively expensive raw materials. When Nb₂O and Ta₂O₅ are included in the glass, weak fluorescence is generated from the glass. Thus, the content of Nb₂O₅ and the content of Ta₂O₅ need to be 0 to 15% and 0 to 20%, respectively. It is preferable that the glass composition is substantially free from Nb₂O₅ and Ta₂O₅.

### (TiO₂)

TiO₂ is an essential component. TiO₂ is a components that decreases the Abbe number efficiently. TiO₂ also has an effect of suppressing fluorescence from the glass induced by ZnO. However, since TiO₂ also is a nucleator, devitrification may be generated in the glass. Therefore, the content of TiO₂ needs to be more than 0.02% but not more than 10%. The content of TiO₂ is preferably 0.1 to 10%, more preferably 1 to 10%, and further preferably 1 to 6%.

### (Iron Oxide)

Iron oxides are present in the form of Fe₂O₃ and/or FeO in a typical glass composition. In the present description, the contents of iron oxides are expressed as a content of a total iron oxide obtained by converting all of the iron oxides into Fe₂O₃, and the total iron oxide may be abbreviated as T-Fe₂O₃.

Since Fe₂O₃ in the glass composition has, in the visible light region, an absorption band attributable to d-d transition of Fe³⁺ ions, it absorbs part of the energy of visible light irradiated as excitation light. In absorbing energy, most of the energy is released as heat, and part thereof appears as fluorescence. If Fe₂O₃ is small in amount, Fe³⁺ ions are small in number accordingly, and thus visible light energy to be absorbed also decreases. As a result, fluorescence from the glass is also reduced. Thus, it is preferable that Fe₂O₃ included in the glass is smaller in amount.

As a method for reducing the amount of Fe₂O₃, there is a method of using a reducing agent such as carbon to convert Fe₂O₃ into FeO, thereby relatively reducing the content of Fe₂O₃ in the glass. However, if this method is used for the glass composition of the present invention, TiO₂ may be reduced to Ti₂O₃, which causes a color defect in the glass. In view of this, by using a reducing agent in an amount enough to keep TiO₂ from being reduced to Ti₂O₃, it is possible to reduce Fe³⁺ ions included in the glass to Fe²⁺ ions so as to reduce fluorescence generated from the glass.

However, even if this method is used, when the content of T-Fe₂O₃ included in the glass is large, the content of Fe³⁺ ions included in the glass increases. Hence, fluorescence from the glass cannot be reduced sufficiently. Therefore, it is preferable that T-Fe₂O₃ itself included in the glass is smaller in amount. 50 ppm or less of T-Fe₂O₃ included makes it possible to reduce fluorescence from the glass sufficiently when visible light is irradiated as excitation light.

Of course, the generation of fluorescence is related to the ratio between Fe₂O₃ and FeO in the glass composition. However, when T-Fe₂O₃ is 50 ppm or less, it may be difficult in some cases to measure this ratio accurately. Thus, in the present invention, generation of fluorescence is suppressed by specifying the content of Fe₂O₃, regardless of the ratio between Fe₂O₃ and FeO.

On the other hand, when T-Fe₂O₃ is excessively small in amount, refinement of the glass melt may be deteriorated. As a result, glass articles made from the glass melt may have fine bubbles remaining, which may cause defects in the glass articles. When the content of T-Fe₂O₃ is at least 0.5 ppm, refinement of the glass melt is improved considerably. Thus, the content of T-Fe₂O₃ needs to be 0.5 to 50 ppm. The content of T-Fe₂O₃ is preferably 0.5 to 20 ppm, more preferably 0.5 to 10 ppm, further preferably 0.5 to 6 ppm, and particularly preferably 1 to 6 ppm.

### (Silica Materials)

It is absolutely necessary to use a high purity silica material in order to limit the content of T-Fe₂O₃ in the glass within the above-described ranges. When glass is industrially manufactured, silica sand is used as a SiO₂ source material. The silica sand, however, usually includes iron oxide. Thus, it is necessary to use, as a SiO₂ source material, a silica material that contains less impurities. As a high purity silica material, synthetic silica powder that is industrially manufactured from a starting material such as SiCl₄ and silicon alkoxide can be used suitably.

In the glass composition of the present invention, the content of SiO₂ is 60 to 79 mass % and the content of T-Fe₂O₃ is at most 50 mass ppm. Thus, when the iron oxides are derived from a silica material, the content of T-Fe₂O₃ in the silica material should be set to about 80 ppm or less, so that the content of T-Fe₂O₃ can be at most 50 mass ppm in the glass composition.

Furthermore, taking into consideration an unavoidable admixture of impurities during production of glass, the content of T-Fe₂O₃ in the silica material is preferably 10 ppm or less, more preferably 1 ppm or less, further preferably 0.5 ppm or less, and particularly preferably 0.3 ppm or less.

### (Refining Agent and Remaining Amount Thereof)

In the glass composition of the present invention, refining agent components can be provided. Conventionally, As₂O₃ and Sb₂O₃ are preferably used as refining agent components in producing glass for a cover glass. Since these components are substances that are likely to have harmful effects to environment, it is not recommendable to use them. Thus, it is desirable not to include these components except for unavoidable inclusion of them as impurities in producing glass. In the present invention, examples of the refining agent components include SO₃, Cl and F. SO₃ is preferable among these refining agent components. As a source material of SO₃, a sulfate salt such as Na₂SO₄, K₂SO₄, BaSO₄, and CaSO₄ can be used. The content (remaining amount) of SO₃ is 0 to 1%, preferably 0.01 to 1%, and more preferably 0.01 to 0.2%.

Cl, which is generated from a raw material such as NaCl, is used suitably as a refining agent component. However, Cl may cause striae in glass articles due to its volatilization from the glass melt in melting the glass composition. In addition, Cl may make it difficult to adjust the refractive index. Thus, the content (remaining amount) of Cl needs to be 1% or less, and is preferably less than 0.1%.

F also is a suitable refining agent component. However, like Cl, F may cause striae in glass articles due to its volatilization from the glass melt in melting the glass composition. In addition, F may make it difficult to adjust the refractive index. Thus, the content (remaining amount) of F needs to be 1% or less, and is preferably less than 0.1%. It is more preferable that the glass composition is substantially free from F. A typical example of a source material of F includes CaF₂.

### (Other Impurities)

It is preferable that the contents of other coloring components or components that cause fluorescence are lower. Examples of these components include compounds including at least one selected from the group consisting of V, Cr, Mn, Co, Ni, Cu, Sn, Te, Se, Pb, Bi, Ce and rare earth elements. Furthermore, the examples also include compounds including Au, Rh or Pt. In order to reduce fluorescence from the glass sufficiently, the total amount of these components is preferably 200 ppm or less. It should be noted that since these components also may cause a color defect or fluorescence, the definition of the phrase “substantially free from” is not applied to them.

### (Other Oxides)

Other oxides may be added to the above-mentioned glass composition up to at most 5% in total as long as they do not impair the properties of reducing fluorescence from the glass. Examples of these oxides include P₂O₅, ZrO₂, Rb₂O and Cs₂O.

(Refractive Index n_{d})

Although the refractive index n_{d} of the glass composition of the present invention is not limited, it is preferable that the value of the refractive index n_{d} is 1.519 to 1.530 in some applications. It is more preferable that the refractive index n_{d} is 1.521 to 1.528 in some applications.

(Abbe Number ν_{d})

Although the Abbe number ν_{d} of the glass composition of the present invention is not also limited, it is preferable that the value of the Abbe number ν_{d} is 52 to 60 in some applications. It is more preferable that the Abbe number ν_{d} is 52 to 57 in some applications.

### (Ultraviolet Ray Transmittance)

When a glass composition has a low transmittance of light with a wavelength of 360 nm, part of the absorption edge may affect the visible light region, thereby causing a color defect of the glass. Or, when visible light is used as excitation light, fluorescence may be generated from the glass. Therefore, it is preferable that the glass composition of the present invention has an ultraviolet ray transmittance of at least 85% at a wavelength of 360 nm when measured at a thickness of 1 mm. More preferably, the ultraviolet ray transmittance is at least 90%. It should be noted that the ultraviolet ray transmittance in the present description will be described later.

As has been described above, in the glass composition of the present invention, the contents of Fe₂O₃ and other components are limited, thereby making it possible to suppress the generation of fluorescence from the glass when it is irradiated with visible light. In addition, since the refractive index n_{d} and the Abbe number ν_{d} can be controlled depending on compositions, the glass composition of the present invention can be an optical alternative to a conventional article such as a cover glass. The glass composition of the present invention can be used, for example, as a glass substrate such as a cover glass. Since the glass substrate made of the glass composition of the present invention emits a very weak fluorescence, it is suitable particularly as a glass substrate (a slide glass or a cover glass) for microscope observation.

### EXAMPLES

Hereinafter, the present invention is described with Examples and Comparative Examples. The present invention, however, is not limited to the following Examples.

### (Preparation of Glass Samples)

Each glass sample was prepared according to the following procedure. As raw materials of the glass, high purity silica (having the T-Fe₂O₃ content of 0.25 ppm), boric anhydride, aluminum oxide, sodium carbonate, potassium carbonate, lithium carbonate, magnesium oxide, calcium carbonate, strontium carbonate, barium carbonate, zinc oxide, titanium oxide, ferric oxide, carbon and sodium sulfate were used. The above-mentioned raw materials were mixed together to obtain a predetermined glass composition, and a raw material batch (hereinafter, referred to as a batch) was prepared so that the amount of glass to be melted was 400 g.

The batch thus prepared was melted and refined in a platinum crucible. Firstly, each batch was charged into this crucible, and the crucible was maintained for four hours in an electric furnace set at a temperature of 1500° C. to melt and refine the batch. After that, the glass melt was poured on an iron plate outside the furnace so that the thickness thereof was about 10 mm, and it was cooled and solidified to obtain a glass. The glass subsequently was subjected to an operation of annealing. The operation of annealing was carried out by keeping the glass in another electric furnace set at a temperature of 550° C. for one hour, and then the electric furnace was turned off to cool down to room temperature. Thus, the glass that had undergone the operation of annealing was obtained as a glass sample.

### Examples 1 to 16 and Comparative Examples 1 to 8

With respect to Examples and Comparative Examples, the glass composition ratios, as well as the optical properties and fluorescence intensity ratios of the obtained glass samples are shown in Tables 1 to 3.

TABLE 1

| | | | | | Comparative | | |
|---|---|---|---|---|---|---|---|
| | | Examples | | | Examples | | |
| | | 1 | 2 | 3 | 1 | 2 | 3 |
| Composition | SiO₂ | 68.6 | 68.6 | 68.6 | 68.6 | 68.6 | 68.5 |
| mass % | Al₂O₃ | 1.7 | 1.7 | 1.7 | 1.7 | 1.7 | 1.7 |
| | Na₂O | 8.1 | 8.1 | 8.1 | 8.1 | 8.1 | 8.1 |
| | K₂O | 9.2 | 9.2 | 9.2 | 9.2 | 9.2 | 9.2 |
| | MgO | 4.6 | 4.6 | 4.6 | 4.6 | 4.6 | 4.6 |
| | CaO | 5.5 | 5.5 | 5.5 | 5.5 | 5.5 | 5.5 |
| | TiO₂ | 2.3 | 2.3 | 2.3 | 2.3 | 2.3 | 2.3 |
| | SO₃ | 0.08 | 0.09 | 0.07 | 0.06 | 0.10 | 0.07 |
| | T-Fe₂O₃ | 4 | 18 | 49 | 105 | 201 | 991 |
| | (mass ppm) | | | | | | |

| | | | | | | |
|---|---|---|---|---|---|---|
| Refractive index n_{d} | 1.522 | 1.522 | 1.522 | 1.522 | 1.522 | 1.523 |
| Abbe number ν_{d} | 57.2 | 57.0 | 56.9 | 56.9 | 56.9 | 56.9 |
| Transmittance (%) at a | 91 | 91 | 91 | 90 | 90 | 87 |
| wavelength of 360 nm when | | | | | | |
| measured at a thickness of 1 mm | | | | | | |
| Relative fluorescence intensity | 1 | 2 | 3 | 4 | 11 | 27 |
| ratio when irradiated with | | | | | | |
| excitation light having a | | | | | | |
| wavelength of 488 nm | | | | | | |
| Overall evaluation | ∘ | ∘ | ∘ | x | x | x |

TABLE 2

| | | Examples | | | | | | | | |
|---|---|---|---|---|---|---|---|---|---|---|
| | | 4 | 5 | 6 | 7 | 8 | 9 | 10 | 11 | 12 |
| Composition | SiO₂ | 62.5 | 71.3 | 61.5 | 63.8 | 66.3 | 64.6 | 64.6 | 64.6 | 70.1 |
| mass % | B₂O₃ | 0 | 0 | 0.1 | 8.5 | 3.4 | 7.2 | 7.2 | 7.2 | 0 |
| | Al₂O₃ | 1.6 | 0 | 0.2 | 3.1 | 1.6 | 4.2 | 4.2 | 4.2 | 2.3 |
| | Li₂O | 0.9 | 0 | 0.5 | 0 | 0 | 0 | 0 | 0 | 0.1 |
| | Na₂O | 11.6 | 11.4 | 7.6 | 6.7 | 12.0 | 6.4 | 6.4 | 6.4 | 9.8 |
| | K₂O | 0 | 3.2 | 7.2 | 7.2 | 6.1 | 7.5 | 7.5 | 7.5 | 6.0 |
| | MgO | 3.2 | 4.7 | 3.1 | 0 | 3.3 | 0 | 0 | 0 | 1.9 |
| | CaO | 7.9 | 6.6 | 7.8 | 0.5 | 4.5 | 0 | 0 | 0 | 3.6 |
| | SrO | 0 | 0 | 1.6 | 0 | 0 | 0 | 0 | 0 | 0.8 |
| | BaO | 12.0 | 0 | 2.4 | 0 | 0 | 0 | 0 | 0 | 1.2 |
| | ZnO | 0 | 0 | 0 | 6.3 | 0 | 5.9 | 5.9 | 5.9 | 0 |
| | Nb₂O₅ | 0 | 0 | 2.0 | 0 | 1.3 | 0 | 0 | 0 | 0.6 |
| | Ta₂O₅ | 0 | 0 | 3.4 | 0 | 0 | 0 | 0 | 0 | 0 |
| | TiO₂ | 0.07 | 2.7 | 2.5 | 3.7 | 1.3 | 4.0 | 4.0 | 4.0 | 3.6 |
| | SO₃ | 0.18 | 0.15 | 0.17 | 0.19 | 0.21 | 0.19 | 0.18 | 0.18 | 0.07 |
| | Cl₂ | 0 | 0 | 0 | 0 | 0 | 0 | 0 | 0.09 | 0 |
| | Sb₂O₃ | 0 | 0 | 0 | 0 | 0 | 0 | 0 | 0 | 0 |
| | T-Fe₂O₃ | 3 | 5 | 3 | 4 | 5 | 9 | 4 | 5 | 5 |
| | (mass ppm) | | | | | | | | | |

| | | | | | | | | | |
|---|---|---|---|---|---|---|---|---|---|
| Refractive index n_{d} | 1.546 | 1.529 | 1.558 | 1.523 | 1.525 | 1.525 | 1.525 | 1.525 | 1.525 |
| Abbe number ν_{d} | 58.8 | 56.0 | 53.4 | 54.1 | 56.8 | 55.0 | 54.9 | 54.9 | 53.5 |
| Transmittance (%) at a | 92 | 90 | 90 | 90 | 91 | 90 | 90 | 90 | 90 |
| wavelength of 360 nm | | | | | | | | | |
| when measured at a | | | | | | | | | |
| thickness of 1 mm | | | | | | | | | |
| Relative fluorescence | 1 | 1 | 3 | 1 | 3 | 2 | 1 | 1 | 3 |
| intensity ratio when | | | | | | | | | |
| irradiated with excitation | | | | | | | | | |
| light having a wavelength | | | | | | | | | |
| of 488 nm | | | | | | | | | |
| Overall evaluation | ∘ | ∘ | ∘ | ∘ | ∘ | ∘ | ∘ | ∘ | ∘ |

TABLE 3

| | | Examples | | | | Comparative Examples | | | | |
|---|---|---|---|---|---|---|---|---|---|---|
| | | 13 | 14 | 15 | 16 | 4 | 5 | 6 | 7 | 8 |
| Composition | SiO₂ | 69.0 | 71.0 | 70.3 | 70.6 | 72.3 | 63.8 | 65.3 | 65.3 | 67.6 |
| mass % | B₂O₃ | 0 | 0 | 0 | 0 | 0 | 8.0 | 0.0 | 0.0 | 0 |
| | Al₂O₃ | 1.7 | 1.7 | 1.7 | 1.7 | 1.4 | 4.2 | 1.6 | 1.6 | 1.5 |
| | Li₂O | 0 | 0 | 0 | 0 | 0 | 0 | 0 | 0 | 0 |
| | Na₂O | 11.1 | 13.5 | 10.2 | 13.4 | 13.1 | 6.3 | 12.5 | 12.6 | 11.2 |
| | K₂O | 3.1 | 0.6 | 4.7 | 1.6 | 0.7 | 7.4 | 1.5 | 1.5 | 1.4 |
| | MgO | 2.0 | 4.7 | 4.7 | 3.4 | 4.1 | 0 | 0 | 1.0 | 3.3 |
| | CaO | 6.4 | 4.5 | 5.3 | 7.5 | 8.1 | 0 | 0 | 0 | 0 |
| | SrO | 0.5 | 0 | 0 | 0 | 0 | 0 | 0 | 0 | 0 |
| | BaO | 0 | 0 | 0 | 0 | 0 | 0 | 0 | 0 | 0 |
| | ZnO | 3.8 | 1.4 | 0 | 0 | 0 | 5.8 | 19.0 | 17.9 | 4.9 |
| | Nb₂O₅ | 0 | 0 | 0 | 0 | 0 | 0 | 0 | 0 | 0 |
| | Ta₂O₅ | 0 | 0 | 0 | 0 | 0 | 0 | 0 | 0 | 10.0 |
| | TiO₂ | 2.3 | 2.5 | 2.9 | 1.7 | 0 | 4.0 | 0 | 0 | 0 |
| | SO₃ | 0.06 | 0.08 | 0.21 | 0.08 | 0.19 | 0.01 | 0.09 | 0.08 | 0.09 |
| | Cl₂ | 0 | 0 | 0 | 0 | 0 | 0.09 | 0 | 0 | 0 |
| | Sb₂O₃ | 0 | 0 | 0 | 0 | 0 | 0.39 | 0 | 0 | 0 |
| | T-Fe₂O₃ | 4 | 4 | 4 | 4 | 900 | 89 | 4 | 5 | 4 |
| | (mass ppm) | | | | | | | | | |

| | | | | | | | | | |
|---|---|---|---|---|---|---|---|---|---|
| Refractive index n_{d} | 1.530 | 1.524 | 1.525 | 1.525 | 1.517 | 1.523 | 1.526 | 1.526 | 1.524 |
| Abbe number ν_{d} | 54.8 | 55.3 | 55.6 | 56.3 | 59.6 | 54.3 | 56.3 | 56.7 | 55.9 |
| Transmittance (%) at a | 91 | 90 | 90 | 91 | 90 | 88 | 90 | 90 | 90 |
| wavelength of 360 nm | | | | | | | | | |
| when measured at a | | | | | | | | | |
| thickness of 1 mm | | | | | | | | | |
| Relative fluorescence | 2 | 1 | 1 | 1 | 21 | 9 | 81 | 68 | 15 |
| intensity ratio when | | | | | | | | | |
| irradiated with excitation | | | | | | | | | |
| light having a wavelength | | | | | | | | | |
| of 488 nm | | | | | | | | | |
| Overall evaluation | ∘ | ∘ | ∘ | ∘ | x | x | x | x | x |

### (Measurement of Refractive Index)

The refractive indices of the glass samples of Examples and Comparative Examples were measured in the following way. Each of the above-mentioned glass samples was shaped into a rectangular parallelepiped of 5 mm×5 mm×15 mm, and the six planes thereof were optically polished. Thus, a glass specimen was prepared. In preparing this glass specimen, common glass processing techniques such as cutting, grinding and optical polishing were used. The refractive index n_{d} relative to a wavelength of 587.6 nm (d-line), the refractive index n_{F} relative to a wavelength of 486.1 nm (F-line), and the refractive index n_{C} relative to a wavelength of 656.3 nm (C-line) were measured using a Pulfrich refractometer (manufactured by Carl Zeiss Jena: Model number PR2). Based on the obtained values, the Abbe number ν_{d} was calculated according to the following equation:

ν_{d}=(n_{d}−1)/(n_{F}−n_{C}). (Equation 1)

The refractive indices n_{d} and the Abbe numbers ν_{d} are also shown in Tables 1 to 3.

### (Measurement of Ultraviolet Ray Transmittance)

With respect to the glass samples of Examples and Comparative Examples, the ultraviolet ray transmittances were measured in the following way. Each of the above-mentioned glass samples was shaped into a square glass sheet having a side of about 30 mm and a thickness of 1 mm, and both of the main surfaces thereof were optically polished. Thus, a glass specimen was prepared. The light transmittance of the glass specimen at a wavelength of 200 to 800 nm was measured using a visible-ultraviolet spectrophotometer (U-4100 manufactured by Hitachi High-Technologies). The measurement results are also shown in Tables 1 to 3. It should be noted that in the present description, the light transmittance at a wavelength of 360 nm is referred to simply as a transmittance.

(Measurement of Fluorescence from Glass)

With respect to the glass samples of Examples and Comparative Examples, the fluorescence intensities were measured in the following way. Each of the above-mentioned glass samples was shaped into a rectangular parallelepiped of 20 mm×10 mm×7 mm, and the six planes thereof were optically polished. Thus, a glass specimen was prepared. The fluorescence of the glass specimen was measured using a fluorescence spectrophotometer (FS-920 manufactured by Edinburgh Instruments). As excitation light, light having a wavelength of 488 nm was used. The measurement was carried out in the range of wavelengths of 500 to 700 nm. All of the samples were set in the same manner to carry out a comparative evaluation of the fluorescence intensities thereof. The evaluation results are shown in Tables 1 to 3 as relative fluorescence intensity ratios.

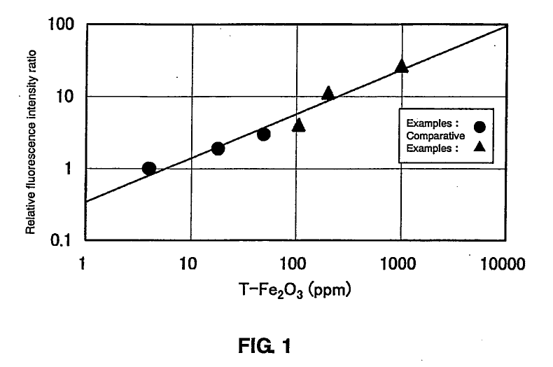

FIG. 1 illustrates a graph showing a relationship between the contents of iron oxides and relative fluorescence intensity ratios. It should be noted that in the present description, a relative fluorescence intensity ratio is defined as a value calculated as follows: The fluorescence intensities at wavelengths of 520 to 700 nm are integrated at 1 nm intervals and the integrated intensity of each of Examples and Comparative Examples is normalized so that the intensity of Example 1 is represented as “1”.

### Comparison Between Examples 1 to 3 and Comparative Examples 1 to 3

The glass compositions shown in Table 1 were obtained by changing the content of iron oxides systematically. As shown in Table 1, each of the glass compositions of Examples 1 to 3 and Comparative Examples 1 to 3 had a refractive index n_{d} of about 1.522 and an Abbe number ν_{d} of about 57. This fact reveals that all the glass compositions of Examples 1 to 3 and Comparative Examples 1 to 3 have both refractive indices and Abbe numbers suitable for a use as cover glasses, for example.

Although all the glass compositions of Examples had ultraviolet ray transmittances of at least 90%, the glass compositions of Comparative Examples had relatively low ultraviolet ray transmittances. This is because the absorption of ultraviolet rays increases as the content of iron oxides increases.

Next, fluorescence intensities are compared with each other. As shown in FIG. 1, the relative fluorescence intensity ratio increases as the amount of iron oxides increases. Comparative Example 3 includes about 1000 ppm of iron oxides. This value is close to that of an industrially manufactured soda-lime glass. The results of the comparison between Examples 1 to 3 and Comparative Examples 1 to 3 show that when the content of iron oxides is 50 ppm or less, the fluorescence intensity can be reduced considerably compared to that of a conventional soda-lime glass.

### Comparison Between Examples 4 to 16 and Comparative Examples 4 to 8

Tables 2 and 3 show a comparison between the glass composition of the present invention and commercially available glass compositions and the like. As shown in Tables 2 and 3, the glass compositions of Examples 4 to 16 and Comparative Examples 4 to 8 have various refractive indices n_{d} and Abbe numbers ν_{d}.

Fluorescence intensities are compared with each other. Each of the glass compositions of Examples 4 to 16, in which the content of iron oxides is limited, has a small value of a relative fluorescence intensity. On the other hand, each of the glass compositions of Comparative Examples 4 and 5, which is a commonly used soda-lime glass or cover glass, has a high content of iron oxides and thus has a high level of fluorescence intensity.

Comparative Examples 6 to 8 are glass compositions that include ZnO but include no titanium oxide. Each of these glass compositions of Comparative Examples 6 to 8 has a low content (4 to 5 ppm) of iron oxides that cause fluorescence when excited with visible light. This content is comparable to that of each Example. These glass compositions, however, showed high levels of fluorescence having relative fluorescence intensity ratios of 15 to 81. In particular, Comparative Example 8 has a relative fluorescence intensity ratio of 15, which is a large value. This is because the glass composition of Example 8 does not include titanium oxide even though it has a lower content of ZnO than Example 10 as well as a comparable content of iron oxides to Example 10. Although Examples 7, 9, 10, 11, 13 and 14 also include ZnO, they all include TiO₂ and thus have relative fluorescence intensity ratios of 1 to 2, which are small values.

The measurement of fluorescence from glass is verified here. According to K. E. Fox et al. (Transition metal ions in silicate melts, Part 2. Iron in sodium silicate glasses: Physics and Chemistry of Glasses, Vol. 23, No. 5, October 1982), it is known that fluorescence induced by Fe³⁺ ions included in silicate glass appears as a broad peak having center wavelengths at around 620 nm and 680 nm.

In the glass composition of the present invention, the center wavelength of the fluorescence peak is approximately 680 nm. As apparent from Examples 1 to 3 and Comparative Examples 1 to 3, when glass compositions are identical in base composition but different only in T-Fe₂O₃ content, they differ only in fluorescence intensity although they are identical in fluorescence peak shape. The wavelength range of 520 to 700 nm in which fluorescence measurement was carried out includes the center wavelengths of these peaks. Thus, the integrated values of fluorescence intensities in this range are appropriate for comparing the fluorescence intensities in the entire range of wavelengths (integrated intensities at all the wavelengths). Furthermore, also in the glass compositions of Examples 4 to 16, the center wavelengths of the fluorescence peaks are approximately 680 nm. Thus, it is possible to adequately compare the fluorescence intensities in the entire range of wavelengths using the integrated value of fluorescence intensity in the range of 520 to 700 nm.

As has been described above, in the present invention, the content of iron oxides is in an adequate range, titanium oxide is included as an essential component, and a suitable refining agent is used. As a result, it is confirmed that a glass composition that has a much lower fluorescence therefrom than that of commercially available conventional glass compositions and is suitable for mass production as well can be obtained.

1. A glass composition comprising the following components, in terms of mass % and mass ppm:
60 to 79% SiO₂;
0 to 13% B₂O₃ (exclusive of 13%);
0 to 10% Al₂O₃;
0 to 10% Li₂O;
more than 0% but not more than 20% Na₂O;
0 to 15% K₂O;
0 to 10% MgO;
0 to 15% CaO;
0 to 15% SrO;
0 to 15% BaO;
0 to 10% ZnO;
0 to 15% Nb₂O₅;
0 to 20% Ta₂O₅;
more than 0.02% but not more than 10% TiO₂; and
0.5 to 50 ppm T-Fe₂O₃ (where T-Fe₂O₃ denotes a total iron oxide obtained by converting all of iron compounds into Fe₂O₃).

2. The glass composition according to claim 1, comprising the following components, in terms of mass % and mass ppm:
60 to 75% SiO₂;
0 to 12% B₂O₃;
0 to 6% Al₂O₃;
0 to 5% Li₂O;
1 to 15% Na₂O;
0 to 10% K₂O;
0 to 10% MgO;
0 to 15% CaO;
0 to 15% SrO;
0 to 15% BaO;
0 to 10% ZnO;
0 to 15% Nb₂O₅;
0 to 20% Ta₂O₅;
0.1 to 10% TiO₂; and
0.5 to 50 ppm T-Fe₂O₃ (where T-Fe₂O₃ denotes a total iron oxide obtained by converting all of iron compounds into Fe₂O₃).

3. The glass composition according to claim 2, comprising the following components, in terms of mass % and mass ppm:
60 to 71% SiO₂;
more than 0% but not more than 12% B₂O₃;
more than 0% but not more than 6% Al₂O₃;
0 to 5% Li₂O;
4 to 15% Na₂O;
0 to 10% K₂O;
0 to 10% MgO;
0 to 15% CaO;
0 to 10% SrO;
0 to 10% BaO;
0 to 8% ZnO;
0 to 15% Nb₂O₅;
0 to 20% Ta₂O₅;
1 to 10% TiO₂; and
0.5 to 50 ppm T-Fe₂O₃ (where T-Fe₂O₃ denotes a total iron oxide obtained by converting all of iron compounds into Fe₂O₃).

4. The glass composition according to claim 3, comprising the following components, in terms of mass % and mass ppm:
62 to 71% SiO₂;
6 to 10% B₂O₃;
1 to 6% Al₂O₃;
4 to 10% Na₂O;
4 to 10% K₂O;
3 to 8% ZnO;
1 to 6% TiO₂; and
0.5 to 50 ppm T-Fe₂O₃ (where T-Fe₂O₃ denotes a total iron oxide obtained by converting all of iron compounds into Fe₂O₃).

5. The glass composition according to claim 2, comprising the following components, in terms of mass % and mass ppm:
60 to 75% SiO₂;
1 to 6% Al₂O₃;
0 to 5% Li₂O;
4 to 15% Na₂O;
0 to 10% K₂O;
0 to 8% MgO;
3 to 12% CaO;
0 to 10% SrO;
0 to 10% BaO;
0 to 10% ZnO;
0 to 15% Nb₂O₅;
0 to 20% Ta₂O₅;
1 to 10% TiO₂; and
0.5 to 50 ppm T-Fe₂O₃ (where T-Fe₂O₃ denotes a total iron oxide obtained by converting all of iron compounds into Fe₂O₃).

6. The glass composition according to claim 5, comprising the following components, in terms of mass % and mass ppm:
62 to 75% SiO₂;
1 to 6% Al₂O₃;
4 to 15% Na₂O;
0 to 10% K₂O;
1 to 8% MgO;
3 to 12% CaO;
0 to 8% ZnO;
1 to 6% TiO₂; and
0.5 to 50 ppm T-Fe₂O₃ (where T-Fe₂O₃ denotes a total iron oxide obtained by converting all of iron compounds into Fe₂O₃).

7. The glass composition according to claim 1,
wherein the content of T-Fe₂O₃ is 0.5 to 20 ppm in terms of mass ppm.

8. The glass composition according to claim 7,
wherein the content of T-Fe₂O₃ is 0.5 to 10 ppm in terms of mass ppm.

9. The glass composition according to claim 7,
wherein the content of T-Fe₂O₃ is 0.5 to 6 ppm in terms of mass ppm.

10. The glass composition according to claim 7,
wherein the content of T-Fe₂O₃ is 1 to 6 ppm in terms of mass ppm.

11. The glass composition according to claim 1, comprising the following components as a refining agent, in terms of mass %:
0 to 1% SO₃;
0 to 1% Cl; and
to 1% F.

12. The glass composition according to claim 11, comprising 0.01 to 1% SO₃ in terms of mass %.

13. The glass composition according to claim 12, comprising 0.01 to 0.2% SO₃ in terms of mass %.

14. The glass composition according to claim 11, comprising 0 to 0.1% Cl in terms of mass %.

15. The glass composition according to claim 11, comprising 0 to 0.1% F in terms of mass %.

16. The glass composition according to claim 1, being substantially free from As₂O₃ and Sb₂O₃ as a refining agent.

17. The glass composition according to claim 1, having an ultraviolet ray transmittance of at least 85% at a wavelength of 360 nm when formed into a glass sheet having a thickness of 1 mm.

18. The glass composition according to claim 17, having the ultraviolet ray transmittance of at least 90%.

19. The glass composition according to claim 1, having a refractive index n_{d} of 1.519 to 1.530.

20. The glass composition according to claim 19, having the refractive index n_{d} of 1.521 to 1.528.

21. The glass composition according to claim 1, having an Abbe number ν_{d} of 52 to 60.

22. The glass composition according to claim 21, having the Abbe number ν_{d} of 52 to 57.

23. A glass substrate made of the glass composition according to claim 1.

24. A use of a glass substrate made of the glass composition according to claim 1 for a fluorescence microscope observation.
